(19) United States
(12) Patent Application Publication
(10) Pub. No.: US 2002/0076676 A1
(43) Pub. Date: Jun. 20, 2002

(54) Method for improving reading and teaching reading comprehension

(76) Inventor: Mary Lou Kyle, High Point, NC (US)

Correspondence Address: Edward W. Rilee, RHODES & MASON, P.L.L.C., Post Office Box 2974, Greensboro, NC, 27402, US

(21) Appl. No.: 09/740,203

(22) Filed: Dec. 18, 2000

(51) Int. Cl. G09B 17/00

(52) U.S. Cl. 434/178

(57) ABSTRACT

A reading structure for improving reading and teaching reading comprehension. The structure includes a tutor performing a first reading act aloud, and a tutee performing a second reading act after hearing the first reading. In the preferred embodiment, a progress form is used to record the actions of the tutee. The teaching structure may further include an observer and a plurality of tutor/tutee pairs. A tutor selection process is used to select a potential tutor using an application and interview. After selection, there are training sessions for the tutors. The training sessions may include video training sessions, role-playing, and modeling.

### BACKGROUND OF THE INVENTION

(1) Field of the Invention

The present invention relates generally to teaching methods and, more particularly, to an improved method for improving reading and teaching reading comprehension.

(2) Description of the Prior Art

Critical reading comprehension provides one of the most important tools to navigate everyday life. Several approaches exist for teaching reading and reading comprehension. Among those, for example, are the phonics method and the full block reading method, which do teach people to read. In the phonics method, for example, a student is taught first the sounds created by various letters and letter combinations. Then a students is taught to blend the sounds to create words. After knowing how to create words, a student uses that ability to read sentences, paragraphs, passages and so on. In this way, the reader at least simulates a verbalization or a connection between the visual symbolism and what it is trying to be communicated.

Another method includes the full word method. That is, learning to memorize what a complete word means or what a complete word is, or a combination or grouping of letters is, and then based on that, grouping of the words to create sentences. In both the phonics method and the full word method, the student learns how to read, however, it's somewhat like a musician with a tin ear, that is, the reader does not have a critical understanding of what is being presented. Other aspects that are important in critical comprehension include evaluating, doing pre-evaluation of materials, and understanding the perspective of the presenter. Both the phonics method and the full word visualization method do not address these techniques.

Other ways of learning reading are being read to or reading aloud, and again, these techniques, although they teach one to read, fail to bring out the aspects concerning critical reading and critical thinking. That is again, evaluating not only the literal meaning of the words, but also the inferential meaning. Thus, there is clearly a need for developing a better ability to read and to listen and these techniques are needed for people to be able to navigate through everyday life, for example, being able to differentiate between propaganda and reasonable presentations.

Thus, there remains a need for a new and improved method for improving reading and teaching reading comprehension which provides for one-on-one contact between the tutor and tutee while, at the same time, provides for coordination by a trained observer which evaluates feedback from the teaching sessions.

### SUMMARY OF THE INVENTION

The present invention is directed to a reading structure for improving reading and teaching reading comprehension. The structure includes: a tutor performing a first reading act aloud and a tutee performing a second reading act after hearing the first reading. In the preferred embodiment, a progress form is used to record the actions of the tutee.

The teaching structure may further include an observer and a plurality of tutor/tutee pairs. A tutor selection process is used to select a potential tutor using an application and interview. After selection, there are training sessions for the tutors. The training sessions may include video training sessions, role-playing, and modeling.

An observation sheet is used by the observer to assist the plurality of tutors in their development. The observation sheet includes a location for evaluating the engagement of the tutor and the tutee, a location for recording the demeanor of the tutor, a location for recording the engagement and dependence of the tutee, and a location for recording the tutors teaching.

The teaching structure also may include a debriefing structure to facilitate the interaction of the observer and the plurality of tutors including recording tutor observations, such as a tutor journal, and recording observer observations, such as an observer journal.

The teaching structure also may include a discussion group structure. The discussion group structure may include group members substantially face-to-face, such as facilitated by a substantially round table. The discussion group structure preferably includes the tutors.

In the preferred embodiment, the progress form includes a location for noting the correcting of reading by the tutor, a location for noting the helping by the tutor of the tutee, and a location on the progress form for noting the self-correcting during reading of the tutee.

The first read act may be the reading of a trade book, which has been selected to create interest for the tutee and provide background knowledge. The book may be selected from a regional or national recommendation, including newly benchmarked books. Preferably, the first read act is selected to provide a foundation for the second read act and the reading level of the first read act is approximately the listening comprehension level of the tutee.

The teaching structure also may include tutor development. Tutor development may include at least one of mentoring, leadership, organization, interpersonal skills, and/or reading proficiency. Team shirts may be used to encourage the tutee.

The first read act may further include a retelling to reinforce reading comprehension. In a preferred embodiment, the retelling is after the second read act or after the third read act. It may also further include an activity involving at least the tutee in which the activity is related to a passage of a reading act. For example, the activity may involve at least one of a dot-to-dot exercise, a sequencing exercise, a physical activity, a prediction and estimation exercise, a naming exercise, a counting exercise, a play reading game exercise, a drawing exercise, a problem solving exercise, a clue following exercise, a designing exercise, and/or a matching exercise.

In the preferred embodiment, the tutee selects the material for the second read act. The material for the second read act may be recommended by another tutee. The second read act may be the reading of a passage at a lower reading comprehension level and not from the first read act material.

There may also be a third read act in which the third read act involves the reading of the same materials as that of the second read act for fluency.

In the preferred embodiment, the second read act is independent of the tutor. However, the second read act may be a shared reading of the material, as read in the first read act.

The teaching structure also may include a prediction by at least one of the tutor and the tutee. The prediction may be based on a review of the visual indicia of the material to be read or the verbal indicia of the material to be read. This may include questions concerning the content of the material and statements about the content of the material. The tutee is helped to encourage and support the prediction. The questions may relate to the literal text of the material of at least one of the read materials in the second read, the inferential information of the text, a personal reaction, or personal connection of the material of the read act.

Accordingly, one aspect of the present invention is to provide a reading structure for improving reading and teaching reading comprehension. The structure includes a tutor performing a first reading act aloud, and a tutee performing a second reading act after hearing the first reading.

Another aspect of the present invention is to provide a reading structure for improving reading and teaching reading comprehension. The structure includes a tutor performing a first reading act aloud, a tutee performing a second reading act after hearing the first reading, and a progress form for recording the actions of the tutee.

Still another aspect of the present invention is to provide a reading structure for improving reading and teaching reading comprehension. The structure includes a tutor performing a first reading act aloud, a tutee performing a second reading act after hearing the first reading, a progress form for recording the actions of the tutee, and an observer and a plurality of tutor/tutee pairs.

These and other aspects of the present invention will become apparent to those skilled in the art after a reading of the following description of the preferred embodiments, when considered with the drawings.

### BRIEF DESCRIPTION OF THE DRAWINGS

FIG. 1 depicts a schematic of a teaching structure constructed according to the present invention;

FIG. 2 depicts a phase substructure according to an embodiment of the present invention;

FIG. 3 is a flow chart depicting the substructure of Phase 1 of FIG. 2;

FIG. 4 is a flow chart of the substructure of Phase 2 of FIG. 2;

FIG. 5 is a substructure of Phase 3 depicted in FIG. 2;

FIG. 6 is a substructure of the prepare and act substructure of FIGS. 3-5;

FIG. 7 is an observer tutor interaction diagram;

FIG. 8 is a substructure for the observer tutor interaction; and

FIG. 9 is a diagram for the selection process of tutors.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

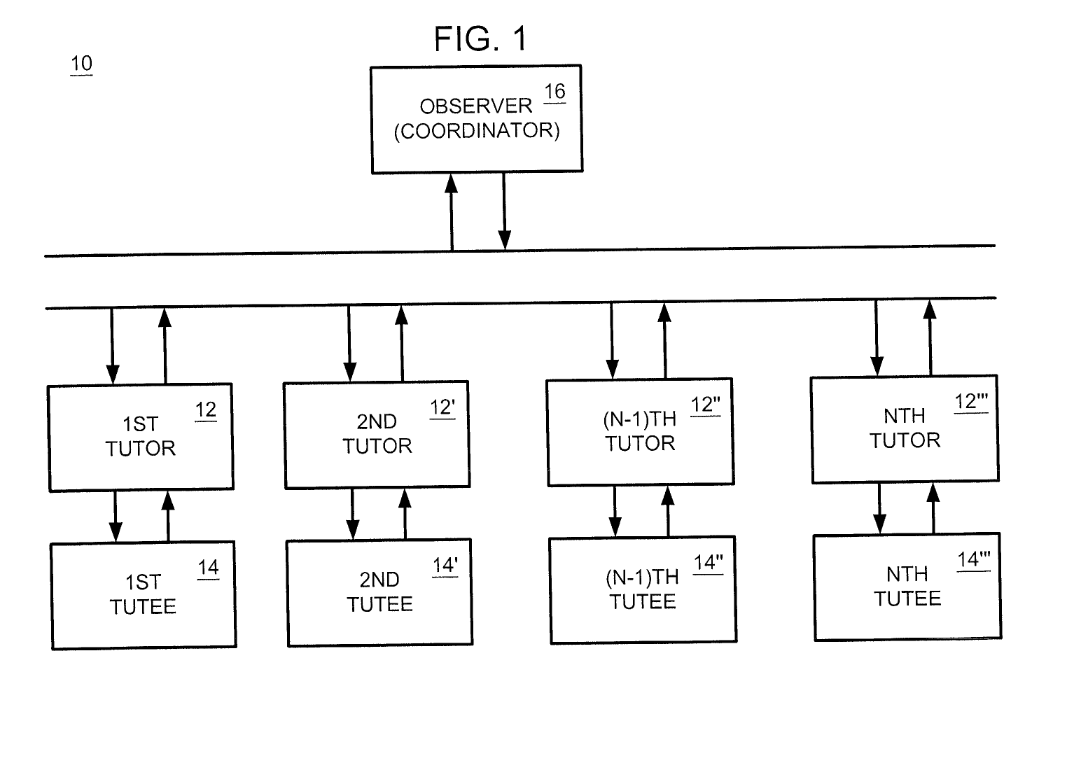

Referring now to the drawings in general and FIG. 1 in particular, it will be understood that the illustrations are for the purpose of describing a preferred embodiment of the invention and are not intended to limit the invention thereto. As best seen in FIG. 1, a method for improving reading and teaching reading comprehension, generally designated 10, is shown constructed according to the present invention. FIG. 1 illustrates the interaction of a tutor 12 and a tutee 14 according to the present invention.

In the preferred embodiment, an observer 16 may interact with a group of several tutor/tutee pairs. The point being that the tutor and the tutee interact in a way to improve the reading skills of both. That is, the tutor learns various aspects relating to mentoring, leadership, organization, interpersonal interaction, and reading proficiency by teaching a tutee to learn to become self-reliant in selecting, reading, and evaluating reading materials.

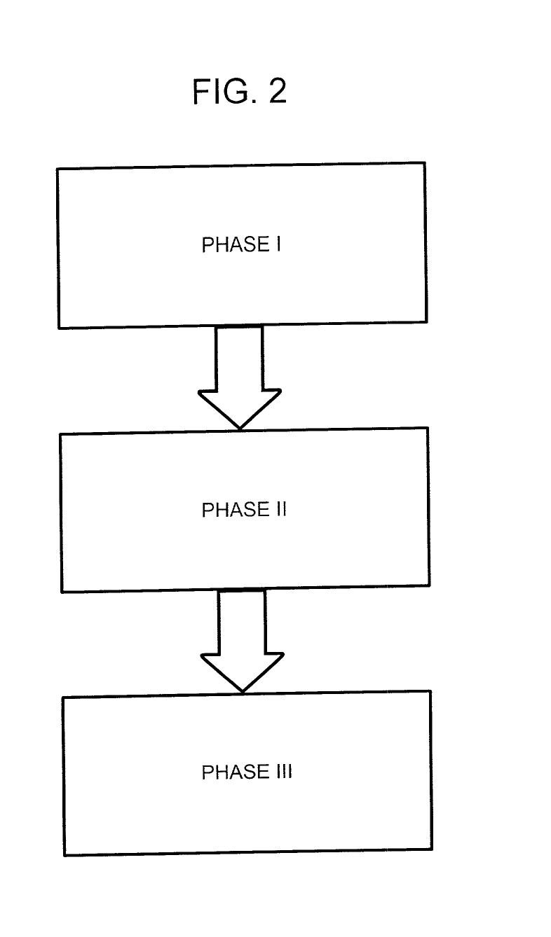

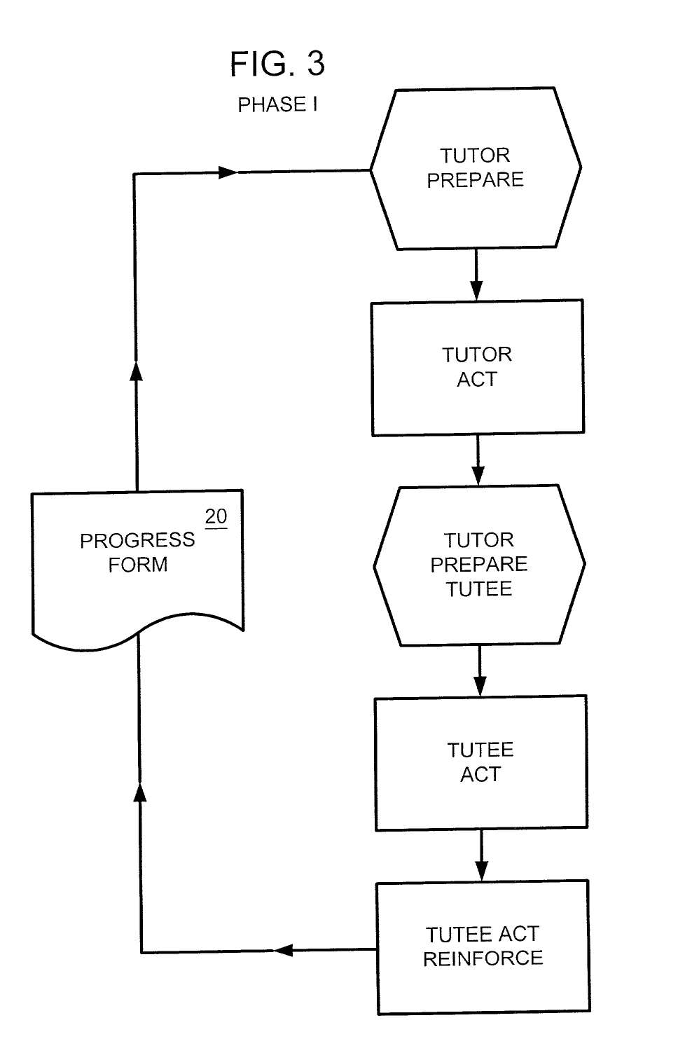

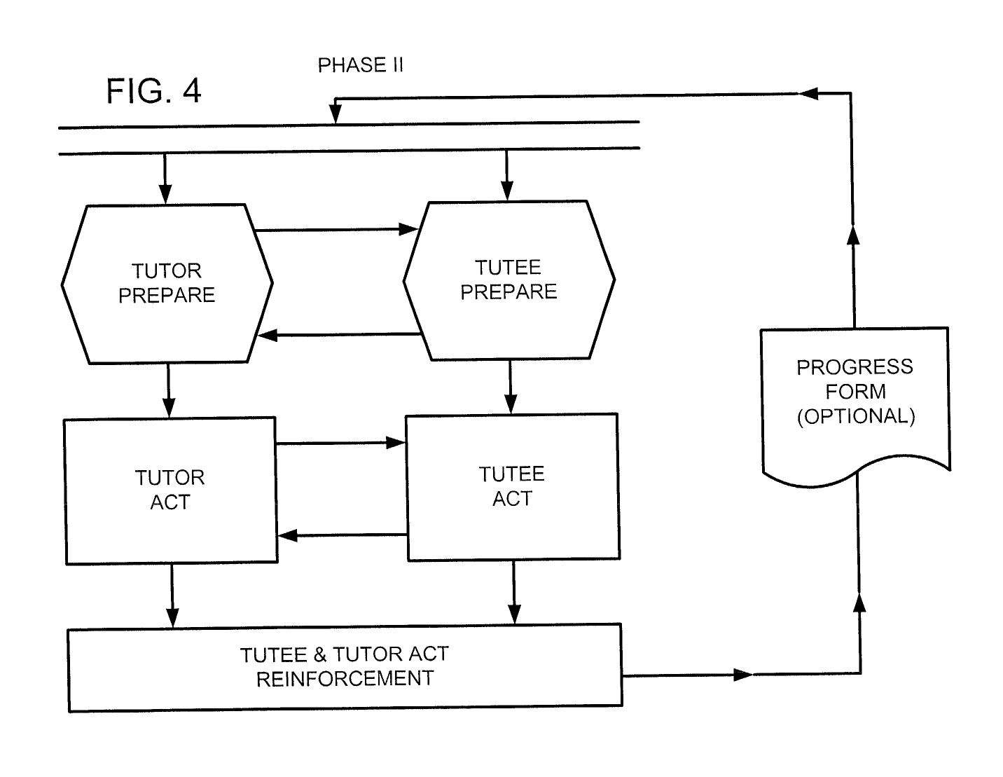

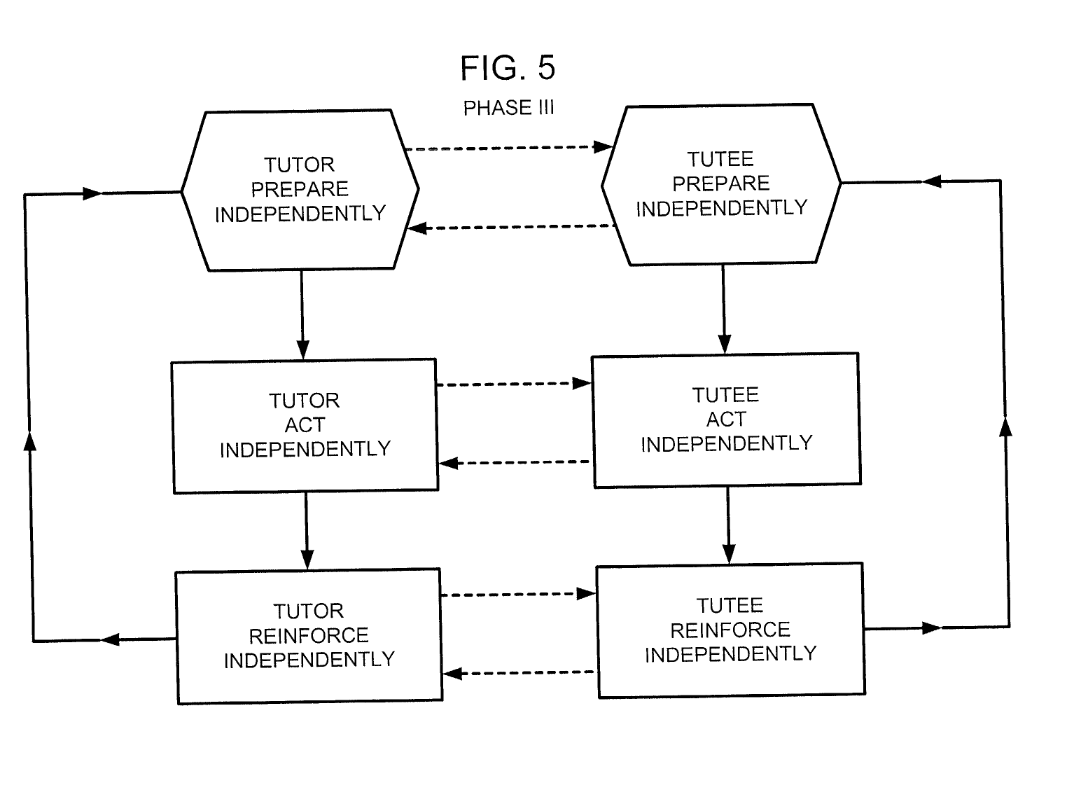

The various phases of the teaching system is shown schematically in FIGS. 2, 3, 4 and 5. In particular, a first phase might be characterized as a serial phase. That is, the tutor takes certain actions with the tutee observing, then the tutee mimics these similar actions. In a second phase, depicted in detail in FIG. 3, the tutor and the tutee work in a parallel manner. That is, the tutor takes and assists the tutee in certain steps and also performs certain acts as well as the tutor and the tutee doing acts together that reinforce the critical reading skills being developed. Finally, in the third phase, as depicted in more detail in FIG. 5, the tutor and the tutee may be individual, the tutor having assisted a tutee has developed better personal interaction skills. Specifically, by reinforcing in the tutee good critical reading skills, the tutor also has developed those skills. In this way, the reading structure of the present invention not only develops a new reader, but also further reinforces a competent reader to a higher level.

Referring now to FIG. 3, there is depicted a feedback loop diagram illustrating the interaction between the tutor and the tutee to start reinforcing positive reading skills in the tutee; one can start at the tutor preparation block. In the tutor preparation block, the tutor may prepare by reviewing materials that he will be working with the tutee on, and by understanding the point of the function of the lesson. After the tutor has reviewed those materials, the tutor would go ahead and act.

One form of acting is by reading aloud to the tutee. In this way, the tutee experiences the reading process. Subsequent to the reading, the tutor may guide the tutee through a preparation for a reading to be done by the tutee.

After the preparation step, the tutee takes a step. One such step may include a reading by the tutee of the passage that the tutor has guided the tutee through the preparation. Another step may include the tutee reading the material read by the tutor, in which case, the material read by the tutor would be of a level that the tutee could read. Other steps may include the tutee preparing for the reading of his own material, which is at a different reading level than the tutor read material which was selected to create interest for the tutee and provide background knowledge. Yet another step may include the tutee retelling the story just read. This retelling may occur after a second read act and preferably occurs after a third read act.

Finally, after the tutee acts, there are certain further actions that the tutee might be involved in that would reinforce the passage or exercise that he has just done. For example, the tutee may have read a story relating back to the original passage, and then do certain types of activities that would reinforce the reading that was just made. Different activities might include, for example, doing a dot-to-dot exercise or sequencing a group of events chronologically. Other activities might include physical activities such as acting out the story, predicting what might have happened, naming, counting, playing reading games, drawings, problem solving, following clues, designing figures and even matching. During such activities and, preferably during a reading, the tutor may use a progress form to note the different action and reactions of the tutee. The tutor may use the information of the progress form to positively and constructively reinforce the tutee in the techniques of the reading structure. Some of the reactions that the tutor could note are the correcting of reading or whether there is help needed with the reading, as well as whether the tutee is correcting himself during reading.

As shown in Phase 2, the tutor and the tutee perform tasks somewhat in parallel. In this instance, the tutor would be reading materials to the tutee of different levels. This is beneficial in that a person of comprehension or listening ability is typically greater than their reading ability and can be as great as two grade levels greater than the reading ability. In this way, the tutor demonstrates the preparation techniques, after which he aids the tutee in preparation techniques. Then the tutor may read the materials that are of a higher comprehension level for the tutee reading it aloud, where the tutee then also reads his particular part. Once again, the tutor and the tutee can be involved in activities that reinforce the reading done by the tutee. Optionally, in this second phase, a progress form can be used once again to positively and constructively reinforce the techniques of the reading structure.

In Phase 3, the tutor and the tutee are acting somewhat independently (the dashed lines in FIG. 5 represent this somewhat independent interaction). In this phase, some of the activities may be common, however, they become separate after the program is complete. Again, these activities are allowing both the tutor and the tutee to reinforce or expand their abilities, and in particular, their reading abilities.

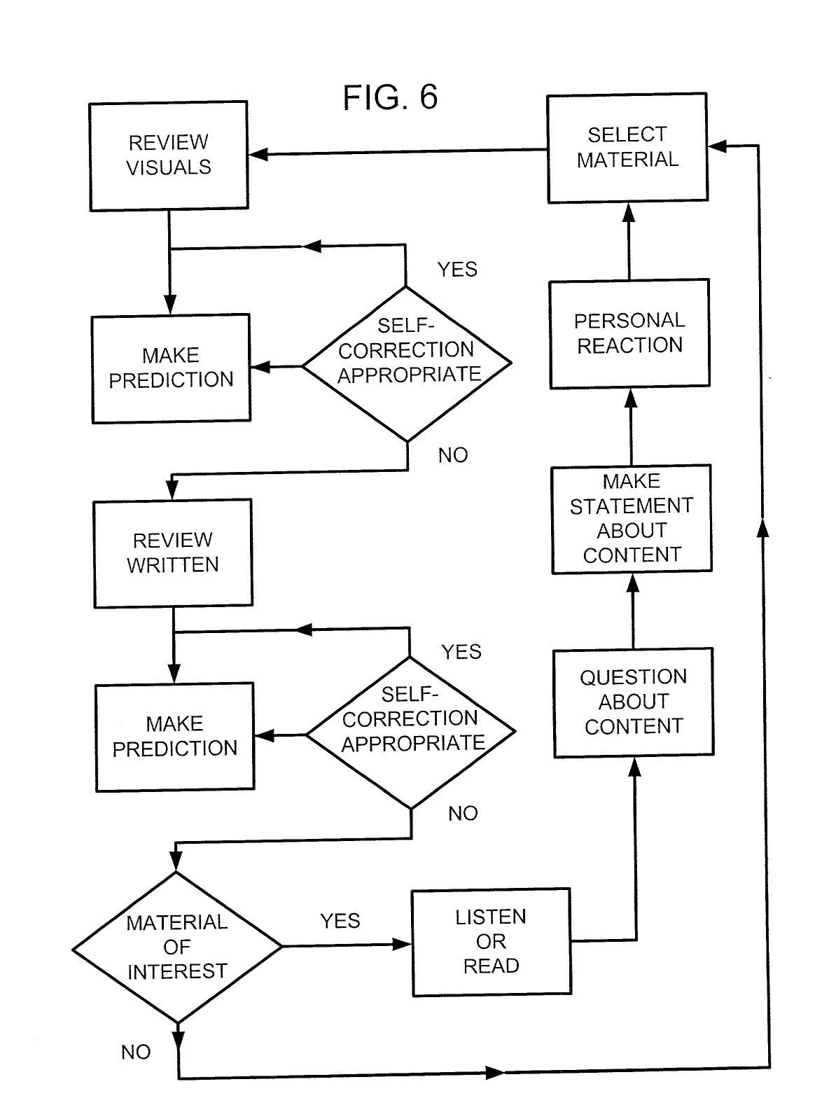

Referring now to FIG. 6, the substructure that prepares and acts as a structure within Phases 1, 2 and 3 is shown. In this case, it is specifically relating to reading materials. The process starts with the selection of materials. The material that is selected within Phase 1 may be materials that are specifically selected by the reading instructor; in Phase 2, the material may be selected by the tutor and tutee; and in Phase 3, material selected may be materials required to accomplish homework tasks, hobby interest, and finally, to the point where the material is now just independent reading within everyday activities.

The first step is selecting the material. The second step, after the material is selected, a visual review of the materials is done. In this visual review, pictures are looked at, the format and layout of the materials within the book, newspaper, magazine, text book, or the like, is looked at, and based on this visual review and the presentation, one makes a prediction about the subject matter of the material to be read.

Early in Phase 1, there is a self-correction that is encouraged by the tutor in the tutee. This may be done by a Socratic-type method, an inquiry method, asking leading questions, and/or asking the tutee to make a prediction based on the visual and textual aspects of the subject matter to have the tutee guess where the materials to be read might be leading. The tutor may use this questioning method to try to help direct the tutee in developing the prediction and self-correcting skills. In all cases, the tutor is interacting with the tutee in a positive manner, such as, a manner that encourages inquiry, the use of the imagination, and critical thinking by the tutee.

Another aspect of self-correction includes a review of the written materials. Here, different aspects of the written material might be reviewed, for example, Chapter Headings, Section Headings, Book Titles, Author's names, and/or indexes, based on those materials. Once again, the tutee is asked to make a prediction. Again, as in Phase 1, since the tutor works with the tutee to encourage the tutee to be self-correcting of their predictions and help the tutee to come to a prediction that may lead to an understanding of what the material is about.

Finally, after the self-correction and the prediction phase, then the question is the material of interest. Now, when the material is part of the subject matter of the program initially, it is set out that the material is specifically followed and selected to try to create interest in the reader. When this system might be used, for example, with elementary school students, the materials might be more specifically tailored. In other instances where the technique might be used, is by a non-native speaker to learn a non-native language, then those materials might be selected in a way that they would be of interest.

Finally, in Phase 3, the question of interest might be something that the person may want to know to accomplish a particular task, such as, life skills task, a hobby task, and/or a work task. Whether the particular articles are of interest is the next decision. If one comes to the ‘no’ answer, then again, the feedback would be for selecting other materials for reading. In the case that it is of interest, listening to or reading of the material is the next step.

Following the listening or reading, questions can be asked of the content and in the case of a tutor and tutee, the tutor would be asking the tutee questions about content. Some of these questions might relate to the literal meaning of the story within the text and other questions might relate to the inferred meaning from the text. Yet, other questions that might be asked are “What is the perspective of the author?” “What is the author advocating?” “Is there some underlying meaning that is resulting because of the author's point or advocacy?”. The next phase would be to ask the person to make a statement about the content. Some of these statements could include, for example, what a personal reaction to the content would be. In this way, what the reader is learning is that there may be materials that are read where there is a disagreement with respect to the content and that there is room for that type of disagreement and a way of moving forward.

Finally, the process starts all over again with the selection of the material. The schematic shown in FIG. 6 is applicable to the steps of Phase 1, 2, and 3, and the types of processes that occur in FIG. 6 are then also applicable in helping people to learn to critically evaluate the material that is either presented in written form or in oral form, helping them to differentiate or develop an ability to be a critical thinker which is a very important tool for being able to maneuver through life and a very useful tool in living in an open and democratic society.

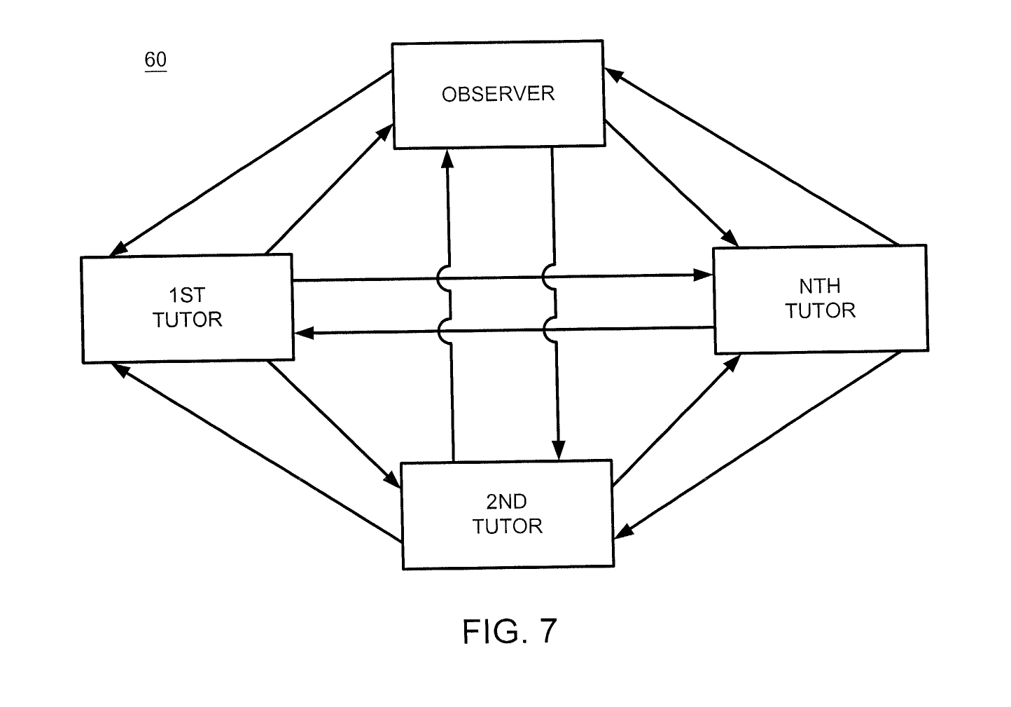

In FIG. 7, there is a schematic showing the interaction of an observer, which in certain instances may be a coordinator and the tutors. A point of the present invention is to help the tutors develop different skills, as noted above, including, for example, mentoring leadership, organization, interaction skills, as well as reading proficiency. One manner of doing this is to allow the tutors to learn from each other, to discuss their interactions with their tutees, discuss the types of techniques that they find have worked, and the types that haven't worked, to allow them to learn how to generally interact with each other on a common peer group, as well as learning to interact between a supervisor and a subordinate.

In the interaction with the observer, the observer is to interact with the tutors in the way that they are acting as a peer, rather than a supervisor, and more in a passive role, with respect to discussing and making suggestions of how to develop better interaction skills.

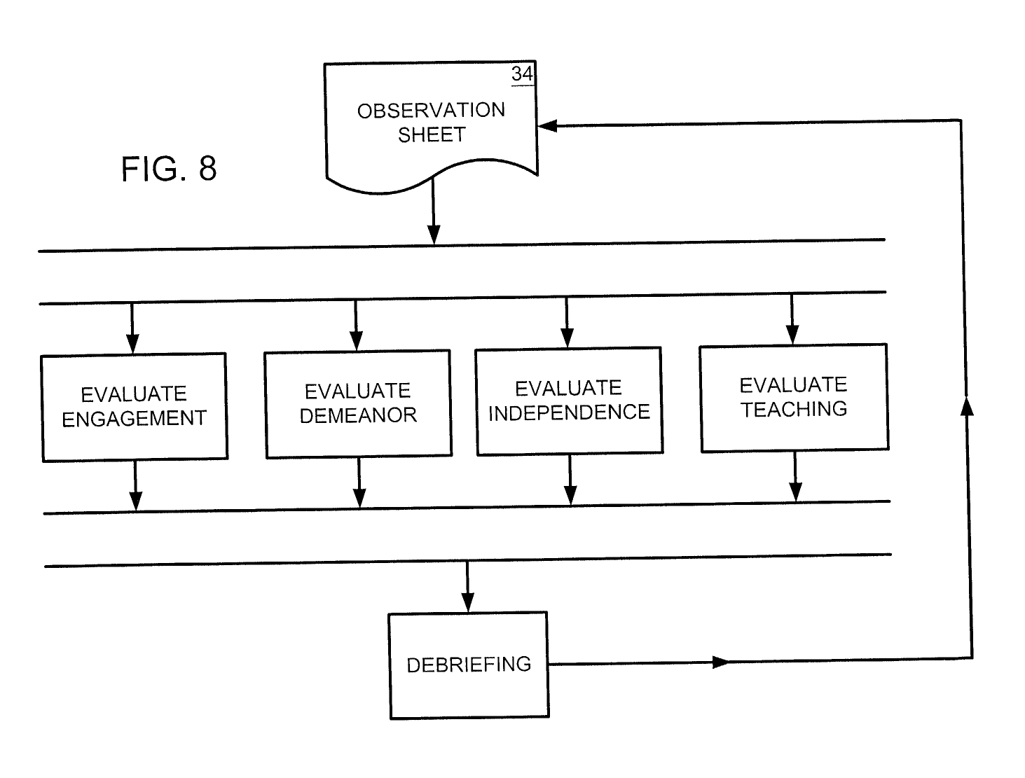

As best seen in FIG. 8, there is another technique used by the observer/tutee interaction. A portion of it is the observer watching the interaction of the tutors and the tutees. During these observations, an observation is used to note and evaluate the engagement between the tutors and the tutees, the demeanor between tutors and tutees, and the independence and responsibility, as well as teaching. In this way, the observer acts in a capacity more as a supervisor rather than a peer.

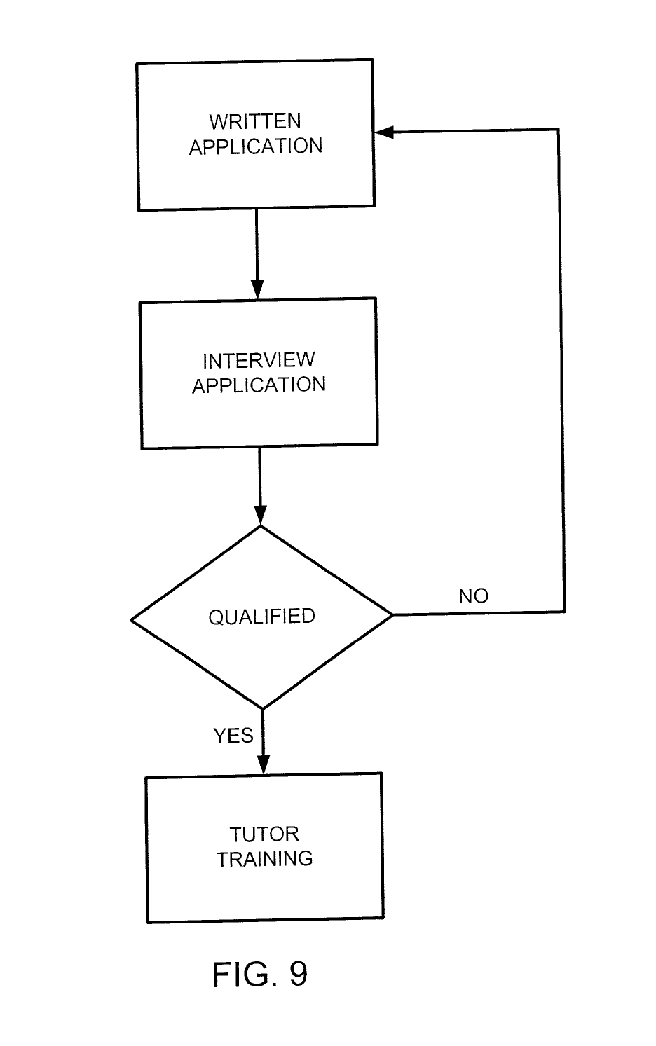

FIG. 9 depicts the process for selecting tutors. In this process, the tutors first complete an application to present various aspects of themselves. Afterward, an observer or a coordinator meets with and interviews the tutor candidates. Once there is a decision made whether the tutor would be qualified, then the tutor is trained. A portion of this training might be done through video films. Other training is done through role-playing (one tutor acting as the tutee and the other acting as the tutor), and through modeling. With respect to the video training, that would show the chronological progression from Phase 1 to Phase 2, and finally, to Phase 3, and in this way, developing the critical thinking and reading abilities that are part of this reading structure.

Certain modifications and improvements will occur to those skilled in the art upon a reading of the foregoing description. By way of example, the tutors develop leadership skills as they prepare the reading lessons, as they present the lessons problem solving “on the go” and reflecting on their lessons in writing and then by discussion. Tutors refine their organizational skills as they participate in training to be a tutor, preparation for each lesson, delivering the lesson, and learning from successes and concerns of the lesson that will have a positive effect for tutors and tutees during the next lesson. Also, tutors increase their own comprehension and confidence in reading as they are tutoring struggling readers. It should be understood that all such modifications and improvements have been deleted herein for the sake of conciseness and readability but are properly within the scope of the following claims.

We claim:

1. A reading structure for improving reading and teaching reading comprehension, said structure comprising:
(a) a tutor performing a first reading act aloud; and
(b) a tutee performing a second reading act after hearing said first reading.

2. The structure according to claim 1, further including an observer and a plurality of tutor/tutee pairs.

3. The structure according to claim 2, further including a tutor selection process.

4. The structure according to claim 3, wherein the selection structure includes an application.

5. The structure according to claim 4, wherein the selection structure includes an interview.

6. The structure according to claim 5, further including training sessions for the tutors.

7. The structure according to claim 6, wherein the training sessions include video training sessions.

8. The structure according to claim 6, wherein the training sessions include role-playing.

9. The structure according to claim 6, wherein the training sessions include modeling.

10. The structure according to claim 7, wherein the training videos are chronological.

11. The structure according to claim 2, further including an observation sheet for use by the observer to assist the plurality of tutors in their development.

12. The structure according to claim 11, wherein the observation sheet includes a location for evaluating the engagement of the tutor and the tutee.

13. The structure according to claim 11, wherein the observation sheet includes a location for recording the demeanor of the tutor.

14. The structure according to claim 11, wherein the evaluation sheet includes a location for recording the engagement and dependence of the tutee.

15. The structure according to claim 11, wherein the observation sheet includes a location for recording the tutors teaching.

16. The structure according to claim 2, further including a debriefing structure to facilitate the interaction of the observer and the plurality of tutors.

17. The structure according to claim 16, wherein the debriefing structure includes a structure for recording observations.

18. The structure according to claim 17, wherein the structure for recording tutor observations includes a tutor journal.

19. The structure according to claim 16, wherein the debriefing structure includes a structure for the observer recording observations.

20. The structure according to claim 19, further including an observer journal.

21. The structure according to claim 16, further including a discussion group structure.

22. The structure according to claim 21, wherein the discussion group structure includes group members substantially face-to-face.

23. The structure according to claim 22, wherein the substantially face-to-face structure is facilitated by a substantially round table.

24. The structure according to claim 21, wherein the discussion group structure includes tutors.

25. A reading structure for improving reading and teaching reading comprehension, said structure comprising:
(a) a tutor performing a first reading act aloud;
(b) a tutee performing a second reading act after hearing said first reading; and
(c) a progress form for recording the actions of the tutee.

26. The structure according to claim 25, wherein the progress form includes a location for noting the correcting of reading by the tutor.

27. The structure according to claim 25, wherein the progress form includes a location for noting the helping by the tutor of the tutee.

28. The structure according to claim 25, further including a location on the progress form for noting the self-correcting during reading of the tutee.

29. The structure according to claim 25, wherein the first read act is the reading of a trade book.

30. The structure according to claim 29, wherein the trade book is selected to create interest for the tutee.

31. The structure according to claim 30, wherein the book is selected from a regional recommendation.

32. The structure according to claim 30, wherein the book is selected from a national recommendation.

33. The structure according to claim 32, further including newly benchmarked books.

34. The structure according to claim 25, wherein the first read act is selected to provide a foundation for the second read act.

35. The structure according to claim 34, wherein the reading level of the first read act is approximately the listening comprehension level of the tutee.

36. The structure according to claim 25, further including tutor development.

37. The structure according to claim 36, wherein the tutor development includes at least one of mentoring, leadership, organization, interpersonal skills, and reading proficiency.

38. The structure according to claim 25, further including team shirts to encourage the tutee.

39. The structure according to claim 25, further including a retelling to reinforce reading comprehension.

40. The structure according to claim 39, wherein the retelling is after the second read act.

41. The structure according to claim 40, wherein the retelling is after the third read act.

42. The structure according to claim 39, further including an activity involving at least the tutee.

43. The structure according to claim 42, wherein the activity is related to a passage of a reading act.

44. The structure according to claim 43, wherein the activity involves at least of: a dot-to-dot exercise, a sequencing exercise, a physical activity, a prediction and estimation exercise, a naming exercise, a counting exercise, a play reading game exercise, a drawing exercise, a problem solving exercise, a clue following exercise, a designing exercise, and a matching exercise.

45. The structure according to claim 25, wherein the tutee selects the material for the second read act.

46. The structure according to claim 45, wherein the material for the second read act is recommended by another tutee.

47. The structure according to claim 25, wherein the read act is the reading of a passage.

48. The structure according to claim 47, wherein the passage is at a lower reading comprehension level.

49. The structure according to claim 48, wherein the passage is not from the first read act material.

50. The structure according to claim 29, further including a third read act.

51. The structure according to claim 50, wherein the third read act involves the reading of the same materials as that of the second read act.

52. The structure according to claim 51, wherein the third read act of the same material as the second read act is done for fluency.

53. The structure according to claim 25, wherein the second read act is independent of the tutor.

54. The structure according to claim 25, wherein the second read act is a shared read of the material as read in the first read act.

55. The structure according to claim 25, further including a prediction by at least one of the tutor and the tutee.

56. The structure according to claim 55, wherein the prediction is based on a review of the visual indicia of the material to be read.

57. The structure according to claim 56, wherein the prediction is based on a review of the verbal indicia of the material to be read.

58. The structure according to claim 57, further including questions concerning the content of the material.

59. The structure according to claim 58, further including statements about the content of the material.

60. The structure according to claim 56, wherein the tutor encourages and supports the prediction.

61. The structure according to claim 58, wherein the questions relate to the literal text of the material of at least one of the read in the second read.

62. The structure according to claim 58, wherein the questions relate to the inferential information of the text.

63. The structure according to claim 58, wherein the questions relate to a personal reaction or personal connection of the material of the read act.

64. A reading structure for improving reading and teaching reading comprehension, said structure comprising:
(a) a tutor performing a first reading act aloud;
(b) a tutee performing a second reading act after hearing said first reading;
(c) a progress form for recording the actions of the tutee; and
(d) an observer and a plurality of tutor/tutee pairs.

65. The structure according to claim 64, further including a tutor selection process.

66. The structure according to claim 65, wherein the selection structure includes an application.

67. The structure according to claim 66, wherein the selection structure includes an interview.

68. The structure according to claim 67, further including training sessions for the tutors.

69. The structure according to claim 68, wherein the training sessions include video training sessions.

70. The structure according to claim 68, wherein the training sessions include role-playing.

71. The structure according to claim 68, wherein the training sessions include modeling.

72. The structure according to claim 69, wherein the training videos are chronological.

73. The structure according to claim 64, further including an observation sheet for use by the observer to assist the plurality of tutors in their development.

74. The structure according to claim 73, wherein the observation sheet includes a location for evaluating the engagement of the tutor and the tutee.

75. The structure according to claim 73, wherein the observation sheet includes a location for recording the demeanor of the tutor.

76. The structure according to claim 73, wherein the evaluation sheet includes a location for recording the engagement and dependence of the tutee.

77. The structure according to claim 73, wherein the observation sheet includes a location for recording the tutors teaching.

78. The structure according to claim 64, further including a debriefing structure to facilitate the interaction of the observer and the plurality of tutors.

79. The structure according to claim 78, wherein the debriefing structure includes a structure for recording observations.

80. The structure according to claim 79, wherein the structure for recording tutor observations includes a tutor journal.

81. The structure according to claim 78, wherein the debriefing structure includes a structure for the observer recording observations.

82. The structure according to claim 81, further including an observer journal.

83. The structure according to claim 78, further including a discussion group structure.

84. The structure according to claim 83, wherein the discussion group structure includes group members substantially face-to-face.

85. The structure according to claim 84, wherein the substantially face-to-face structure is facilitated by a substantially round table.

86. The structure according to claim 83, wherein the discussion group structure includes tutors.

87. The structure according to claim 64, wherein the progress form includes a location for noting the correcting of reading by the tutor.

88. The structure according to claim 64, wherein the progress form includes a location for noting the helping by the tutor of the tutee.

89. The structure according to claim 64, further including a location on the progress form for noting the self-correcting during reading of the tutee.

90. The structure according to claim 64, wherein the first read act is the reading of a trade book.

91. The structure according to claim 90, wherein the trade book is selected to create interest for the tutee.

92. The structure according to claim 91, wherein the book is selected from a regional recommendation.

93. The structure according to claim 91, wherein the book is selected from national recommendation.

94. The structure according to claim 93, further including newly benchmarked books.

95. The structure according to claim 64, wherein the first read act is selected to provide a foundation for the second read act.

96. The structure according to claim 95, wherein the reading level of the first read act is approximately the listening comprehension level of the tutee.

97. The structure according to claim 64, further including tutor development.

98. The structure according to claim 97, wherein the tutor development includes at least one of mentoring, leadership, organization, interpersonal skills, and reading proficiency.

99. The structure according to claim 64, further including team shirts to encourage the tutee.

100. The structure according to claim 64, further including a retelling to reinforce reading comprehension.

101. The structure according to claim 100, wherein the retelling is after the second read act.

102. The structure according to claim 101, wherein the retelling is after the third read act.

103. The structure according to claim 100, further including an activity involving at least the tutee.

104. The structure according to claim 103, wherein the activity is related to a passage of a reading act.

105. The structure according to claim 104, wherein the activity involves at least of: a dot-to-dot exercise, a sequencing exercise, a physical activity, a prediction and estimation exercise, a naming exercise, a counting exercise, a play reading game exercise, a drawing exercise, a problem solving exercise, a clue following exercise, a designing exercise, and a matching exercise.

106. The structure according to claim 64, wherein the tutee selects the material for the second read act.

107. The structure according to claim 106, wherein the material for the second read act is recommended by another tutee.

108. The structure according to claim 64, wherein the read act is the reading of a passage.

109. The structure according to claim 108, wherein the passage is at a lower reading comprehension level.

110. The structure according to claim 109, wherein the passage is not from the first read act material.

111. The structure according to claim 90, further including a third read act.

112. The structure according to claim 111, wherein the third read act involves the reading of the same materials as that of the second read act.

113. The structure according to claim 112, wherein the third read act of the same material as the second read act is done for fluency.

114. The structure according to claim 64, wherein the second read act is independent of the tutor.

115. The structure according to claim 64, wherein the second read act is a shared read of the material as read in the first read act.

116. The structure according to claim 64, further including a prediction by at least one of the tutor and the tutee.

117. The structure according to claim 116, wherein the prediction is based on a review of the visual indicia of the material to be read.

118. The structure according to claim 117, wherein the prediction is based on a review of the verbal indicia of the material to be read.

119. The structure according to claim 118, further including questions concerning the content of the material.

120. The structure according to claim 119, further including statements about the content of the material.

121. The structure according to claim 117, wherein the tutee encourages and supports the prediction.

122. The structure according to claim 119, wherein the questions relate to the literal text of the material of at least one of the read in the second read.

123. The structure according to claim 119, wherein the questions relate to the inferential information of the text.

124. The structure according to claim 119, wherein the questions relate to a personal reaction or personal connection of the material of the read act.
